(19) United States
(12) Patent Application Publication
(10) Pub. No.: US 2007/0256641 A1
(43) Pub. Date: Nov. 8, 2007

(54) DRINKING TROUGH FOR USE IN AVICULTURE

(75) Inventor: Oscar Giordano, Caraglio (Cuneo) (IT)

Correspondence Address: HESLIN ROTHENBERG FARLEY & MESITI PC, 5 COLUMBIA CIRCLE, ALBANY, NY, 12203, US

(73) Assignee: GIORDANO POULTRY PLAST S.p.A., Caraglio (Cuneo) (IT)

(21) Appl. No.: 11/744,466

(22) Filed: May 4, 2007

(30) Foreign Application Priority Data
May 5, 2006 (IT) TO2006U000066

(51) Int. Cl. A01K 7/00

(52) U.S. Cl. 119/72

(57) ABSTRACT

Described herein is a drinking trough for use in aviculture, comprising a container having a flattened shape, provided at the top with an inlet opening for inlet of the drinking liquid and an attachment part for hanging it up, and the bottom of which has a plurality of outlet openings with associated control valves. The container is provided at the bottom with one or more openings equipped with respective removable plugs.

### CROSS-REFERENCE TO RELATED APPLICATIONS

This application claims priority from Italian Patent Application No. TO2006U000066, filed on May 5, 2006, the entire disclosure of which is incorporated herein by reference.

### FIELD OF THE INVENTION

The present invention relates in general to drinking troughs for use in aviculture, i.e., for poultry farms and the like, and regards more in particular a drinking trough of the type comprising a container having a flattened shape, which is provided at the top with an opening for inlet of the drinking liquid and an attachment part for hanging it up, and the bottom of which has a plurality of outlet openings with associated control valves.

### STATE OF THE PRIOR ART

A drinking trough of this type is, for example, illustrated in the patent No. GB-B-2384965.

The container described in the document referred to above is formed by a closed body made of plastic material obtained by injection moulding.

A problem linked to this type of container regards the impossibility of periodic effective washing of the inside thereof. In fact, the only washing method usable consists in introducing a washing liquid through the inlet opening and subsequently expelling it through the same opening. It is evident that such a washing procedure is extremely approximate and moreover inconvenient to carry out since, in order to empty the container, it is necessary to turn it upside down.

### SUMMARY OF THE INVENTION

The present invention solves the problems and disadvantages described above by providing a drinking trough of the type described in the preamble of Claim 1 and characterized in that the container is provided at the bottom with one or more openings, equipped with respective removable plugs.

In particular, in the preferred embodiment two openings are provided set immediately above the opposite ends of the bottom of the container.

In this way, using these two openings the container becomes easy to wash effectively.

A preferred embodiment envisages that the container of the drinking trough according to the invention presents an opening for the introduction of vaccines and/or medicaments.

A further preferred embodiment of the invention envisages that the body of the container presents a central slot designed to facilitate handling of the container, also during washing.

### BRIEF DESCRIPTION OF THE DRAWINGS

Further characteristics and advantages of the invention will emerge clearly in the course of the ensuing detailed description, with reference to the annexed plate of drawings, which is provided purely by way of non-limiting example and in which:

FIG. 1 is a perspective view of a drinking trough for use in aviculture, according to the present invention; and

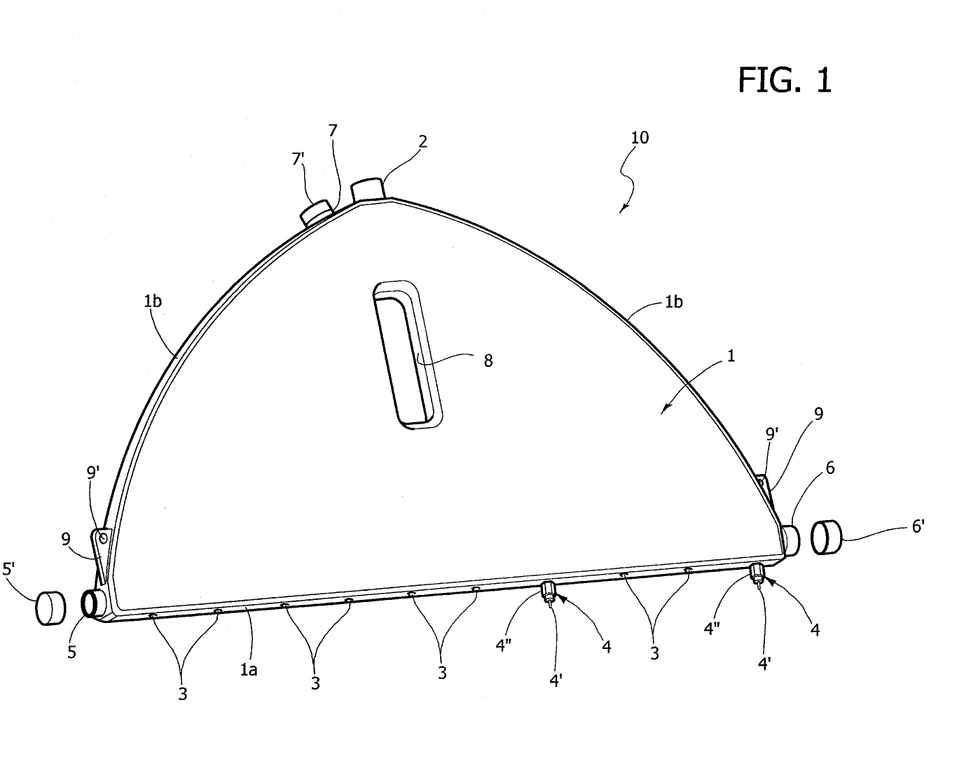

FIG. 2 is a front view of the drinking trough of FIG. 1.

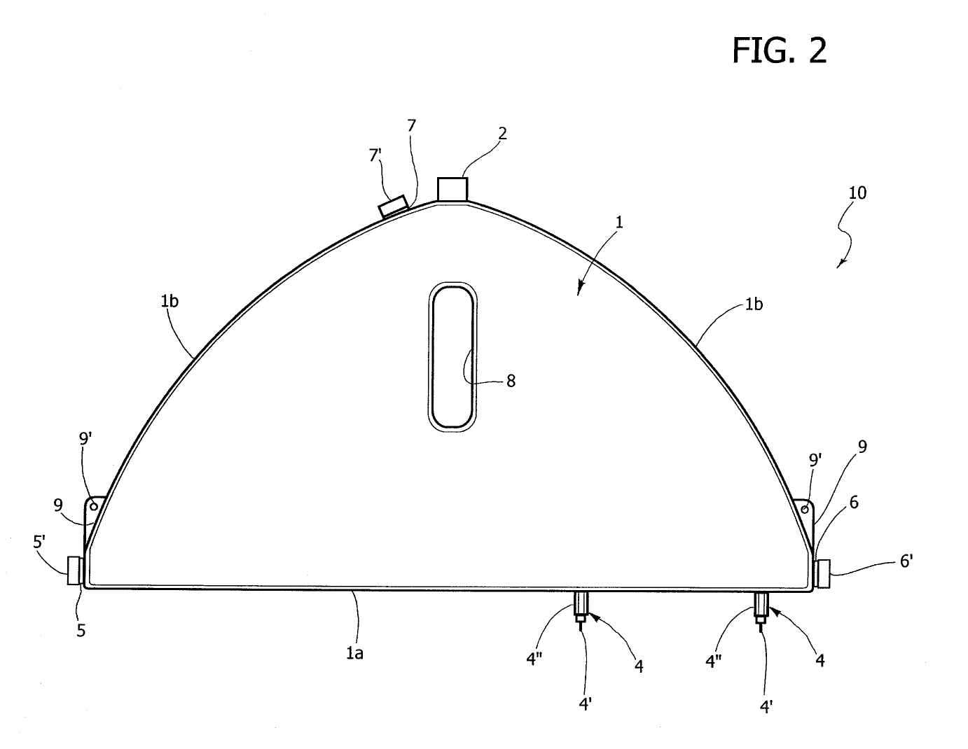

### DETAILED DESCRIPTION OF THE INVENTION

With reference to the drawings, the drinking trough 10 according to the invention comprises a container 1 made of plastic material having a substantially flat profile. The container 1 is crescent-shaped and is defined by a side with rectilinear base 1a and by two curved sides 1b, which are symmetrical with respect to an orthogonal and median axis of the base side 1a.

In a position corresponding to the portion of intersection of the two curved sides 1b, i.e., at the top of the container 1, a tubular mouth 2 is present, having an axis perpendicular to the base side 1a, which constitutes an opening for inlet of the drinking liquids. Said tubular mouth 2 is threaded internally in such a way as to be engaged by a tubular supply connector, with associated attachment member (not shown), for hanging the container 1 up.

Along the base side 1a, a plurality of outlet openings 3 is present, each of which has its own axis perpendicular to the base side 1a.

The openings 3 are intercepted by respective supply control valves 4. Said control valves 4 are of a conventional type already widely used in the sector of drinking troughs. They comprise in brief a pin 4′, which can move within a tubular element 4″ and can be displaced by the beak of the bird to open the flow of the drinking liquid.

Present in a position corresponding to the intersections of the curved sides 1b with the base side 1a are, respectively, two further openings 5, 6, which have their own axis parallel to the base side 1a. Said openings 5, 6 during normal use of the drinking trough are closed by respective plugs 5′, 6′.

The openings 5 and 6 enable periodic washing of the container 1 in a convenient and practical way.

The washing liquid can be introduced through the inlet mouth 2 and made to exit through one and/or the other opening 5, 6 after the respective plugs 5′ and 6′ have been removed.

Alternatively, the washing liquid can be introduced indifferently from the opening 5 or else 6, and expelled from the opening 6 or else 5. In this case, a high-pressure flow can be used so as to remove effectively the debris and dirt that has accumulated on the bottom of the container 1.

A further opening 7 closed by a respective plug 7′, is provided on the top part of the container 1 for introduction of vaccines and/or medicaments, whenever necessary.

In a position corresponding to the central portion of the container 1 a slot 8 is made, which serves to facilitate handling of the drinking trough 10.

Set in a position corresponding to the bottom ends of the curved sides 1b of the container 1 are two projections 9 provided with holes 9′, for example usable for constraining the drinking trough 10 to a fixed structure and hence limiting undesirable oscillations thereof.

According to the present invention, a drinking trough is provided, ideal hygienic conditions of which can be guaranteed thanks to the fact that it can be washed easily and thoroughly.

In addition, the drinking trough according to the invention has a structure that is very simple, inexpensive, of reduced dimensions, and easy to handle.

Of course the details of construction and the embodiments may vary widely with respect to what is described and illustrated herein, without thereby departing from the scope of the present invention as defined in the ensuing claims.

What is claimed is:

1. A drinking trough for use in aviculture, comprising:
a container having a flattened shape, provided at the top with an inlet opening for the drinking liquid and an attachment part for hanging it up, said container having a bottom which has a plurality of outlet openings with associated control valves, wherein said container is provided at the bottom with one or more openings, equipped with respective removable plugs.

2. The drinking trough for use in aviculture according to claim 1, further comprising an opening equipped with a removable plug for introduction of at least one of vaccines and medicaments.

3. The drinking trough for use in aviculture according to claim 1, wherein said one or more openings constitute, respectively, an inlet opening and an outlet opening for the flow of the liquids for washing the container.

4. The drinking trough for use in aviculture according to claim 1, wherein said one or more openings define outlet openings for the flow of liquids for washing the container.

5. The drinking trough for use in aviculture according to claim 1, wherein said container is made of moulded plastic material.

6. The drinking trough for use in aviculture according to claim 1, wherein said container is generally crescent-shaped.

7. The drinking trough for use in aviculture according to claim 1, wherein said container has a slot designed to facilitate handling thereof.
